(19) United States
(12) Patent Application Publication
(10) Pub. No.: US 2008/0092744 A1
(43) Pub. Date: Apr. 24, 2008

(54) APPARATUS FOR PREVENTING OR REDUCING THE OXIDATION OF FOOD

(76) Inventors: Scott Storbo, Miami Beach, FL (US); Scott Gray, Miami Beach, FL (US)

Correspondence Address: DAVIS WRIGHT TREMAINE LLP/Los Angeles, 865 FIGUEROA STREET, SUITE 2400, LOS ANGELES, CA, 90017-2566, US

(21) Appl. No.: 11/550,695

(22) Filed: Oct. 18, 2006

(51) Int. Cl. B01D 53/02

(52) U.S. Cl. 96/108

(57) ABSTRACT

A filter, an apparatus and a method is provided for preventing or reducing the oxidation of food. The apparatus comprises a device that circulates the atmosphere in an enclosed space through particulate and adsorbent filters to reduce the amount of oxidizing agents present in said enclosure.

### FIELD OF INVENTION

The present invention relates to a filter, an apparatus and a method for retarding the spoilage of food by preventing or reducing the oxidation of the food.

### BACKGROUND OF THE INVENTION

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

Most people associate oxidation with the rancid flavors that develop in fatty foods such as nuts and oils. Oxidation is also the cause of color changes and textural changes in many foods, and contributes to the eventual spoilage of food. Although freezing foods can help slow down oxidation it will accelerate dramatically once the product is thawed.

Oxidation is a process that is generally caused by oxygen. However, the primary route of oxidation, in many instances, can be caused by materials other than oxygen. For example hydrogen sulfide or other sulfide compounds, even in small concentrations, particularly in the simultaneous presence of ammonia may contribute to the oxidative process. This process may be accelerated in the presence of water vapor.

The sources and concentrations of hydrogen sulfide in the atmosphere and indoor air are varied. Man-made sources of hydrogen sulfide include industrial emissions from the burning of fossil fuels, natural gas, chemical plants, poorly ventilated sewage lines, sewage treatment facilities, and farms. Natural sources include geothermal emissions, anaerobic bacterial processes, and salt water bodies. In the indoor environment, gaseous by-products from human digestive processes are a major source. It is, therefore, difficult to place a value on what might be considered an average or typical range for hydrogen sulfide concentrations in the atmosphere or indoor environment. The U.S. Environmental Protection Agency (“USEPA”) has estimated that the average concentration for hydrogen sulfide in the atmosphere is 0.1 to 0.3 parts per billion (“ppb”) (see USEPA report number EPA/600/8-86/026F, Health Assessment Document for Hydrogen Sulfide, January 1993). It should be noted that this is an average concentration and peak levels may be higher by several hundred fold as is evident in the USEPA report.

Thus, there is a need in the art for filters, apparatuses and methods to prevent or reduce the oxidation of food.

### SUMMARY OF THE INVENTION

The following embodiments and aspects thereof are described and illustrated in conjunction with apparatuses and methods which are meant to be exemplary and illustrative, not limiting in scope.

The present invention includes filters, apparatuses and methods for preventing or reducing the oxidation of food. Various embodiments provide apparatuses for preventing or reducing the oxidation of food, comprising an adsorbent and a device to circulate air through said adsorbent to remove an agent that causes or contributes to the oxidation of food. Said adsorbent may be a physisorber, a chemisorber, an ion exchange material, a catalytic agent and combinations thereof. Said physisorber may be activated carbon, activated alumina, silica, silica gel, natural zeolite, synthetic zeolite, a molecular sieve and combinations thereof, and said chemisorber may be potassium permanganate, calcium carbonate, calcium sulfate, sodium carbonate, sodium hydroxide, calcium hydroxide, powdered metal, a reactant capable of scavenging gas phase contaminants and combinations thereof.

In one embodiment, the apparatus further comprises a first porous layer, wherein said adsorbent is adhered to or non-adheredly placed next to said first porous layer, whereby an adsorbent filter is created. In another embodiment, the apparatus further comprises a second porous layer, wherein said adsorbent is configured between said first porous layer and said second porous layer. In another embodiment, said adsorbent filter further comprises a halide or a metal halide. The metal of said metal halide may be zinc, aluminum, magnesium, calcium, iron and combinations thereof. In another embodiment, the apparatus further comprises a removable filter cartridge that encases said adsorbent.

In another embodiment, the apparatus further comprises an intake vent to allow air to flow into said apparatus, a pre-filter to allow air to flow through said pre-filter prior to flowing through said adsorbent, and an exhaust vent to allow air to flow out of said apparatus.

In another embodiment, the apparatus further comprises a timing device to control the amount of time that the apparatus operates.

In another embodiment, the apparatus further comprises a light sensor adapted to turn on the apparatus.

In another embodiment, the apparatus is adapted for use in a food storage unit selected from the group consisting of a refrigerator, a freezer, a fruit bowl, a bread box and combinations thereof. In another embodiment, the apparatus is adapted for use in an air circulation system.

Other embodiments of the present invention include filters adapted for preventing or reducing the oxidation of food, comprising an adsorbent to remove an oxidizing agent and a porous layer to hold and/or protect said adsorbent, wherein said adsorbent may be activated carbon, activated alumina, silica, silica gel, natural zeolite, synthetic zeolite, a molecular sieve, potassium permanganate, calcium carbonate, calcium sulfate, sodium carbonate, sodium hydroxide, calcium hydroxide, powdered metal, a reactant capable of scavenging gas phase contaminants, an ion exchange material, a catalytic agent and combinations thereof. In one embodiment, the filter may further comprise a halide or a metal halide added to said adsorbent. The metal of said metal halide may be zinc, aluminum, magnesium, calcium, iron and combinations thereof.

In one embodiment, the filter is adapted for use in a refrigerator, a freezer, a fruit bowl, a bread box or combinations thereof. In another embodiment, the filter is adapted for use in an air circulation system.

Additional embodiments provide for methods for inhibiting or reducing the oxidation of food, comprising providing an apparatus comprising an adsorbent and a device to circulate air through said adsorbent to remove an oxidizing agent that causes or contributes to the oxidation of the food, and circulating the air through said apparatus to prevent or reduce the oxidation of the food.

In one embodiment, the apparatus used in the method further comprises a first porous layer, wherein said adsorbent is adhered to or non-adheredly placed next to said first porous layer, whereby an adsorbent filter is created. In another embodiment, the apparatus used in the method further comprises a second porous layer, wherein said adsorbent is configured between said first porous layer and said second porous layer.

In an additional embodiment, the apparatus used in the method further comprises an intake vent to allow air to flow into said apparatus, a pre-filter to remove a particulate contaminant prior to allowing the air to flow through said adsorbent and an exhaust vent to allow air to flow out of said apparatus. Said adsorbent may be a physisorber, a chemisorber, an ion exchange material, a catalytic agent and combinations thereof. Said physisorber may be activated carbon, activated alumina, silica, silica gel, natural zeolite, synthetic zeolite, a molecular sieve and combinations thereof, and said chemisorber may be potassium permanganate, calcium carbonate, calcium sulfate, sodium carbonate, sodium hydroxide, calcium hydroxide, powdered metal, a reactant capable of scavenging gas phase contaminants and combinations thereof. In another embodiment, the filter used in the method further comprises a halide or a metal halide. The metal of said metal halide may be zinc, aluminum, magnesium, calcium, iron and combinations thereof.

An additional embodiment of the invention provides for an apparatus to prevent the spoilage of food, comprising a container to store the food, an adsorbent filter to remove an oxidizing agent, a fan to circulate the air through said adsorbent filter and a base adapted to provide electricity to said apparatus.

Other features and advantages of the invention will become apparent from the following detailed description, taken in conjunction with the accompanying drawings, which illustrate, by way of example, various features of embodiments of the invention.

### BRIEF DESCRIPTION OF THE DRAWINGS

Exemplary embodiments are illustrated in the referenced figures. It is intended that the embodiments and figures disclosed herein are to be considered illustrative rather than restrictive.

FIG. 1 depicts a cross sectional portion of an adsorbent filter in accordance with an embodiment of the present invention.

FIG. 2 depicts an exemplary configuration of an apparatus for preventing or reducing the oxidation of food in accordance with an embodiment of the present invention.

FIG. 3 depicts an exemplary configuration of an apparatus for preventing or reducing the oxidation of food in accordance with an embodiment of the present invention.

FIG. 4 depicts an apparatus that may be placed into or adapted to be used in a drawer of a refrigerator or freezer in accordance with an embodiment of the present invention.

FIG. 5 depicts enclosed bowl that may store and prevent the spoilage of food in accordance with an embodiment of the present invention.

### DETAILED DESCRIPTION OF THE INVENTION

All references cited herein are incorporated by reference in their entirety as though fully set forth. Unless defined otherwise, technical and scientific terms used herein have the same meaning as commonly understood by one of ordinary skill in the art to which this invention belongs.

One skilled in the art will recognize many methods and materials similar or equivalent to those described herein, which could be used in the practice of the present invention. Indeed, the present invention is in no way limited to the methods and materials described. For purposes of the present invention, the following term is defined below.

“Oxidizing agent” as used herein refers to an agent capable of reacting with food to oxidize the food, and thereby causes or contributes to the spoilage of food. Examples of oxidizing agents include but are not limited to hydrogen sulfide, sulfur oxides, carbonyl sulfide, carbon disulfide, nitrogen oxides, ozone, halogen gases, ammonia, ammonium salts, and combinations thereof. One skilled in the art will recognize other agents that are capable of reacting with food and oxidizing the food.

The present invention uses adsorbents capable of removing oxidizing agents from the surrounding air. Adsorbents having high adsorptive capacity for oxidizing agents may be used to remove the oxidizing agents from the surrounding air. These adsorbents may be physisorbers (e.g., activated carbon, activated alumina, silica, silica gel, natural or synthetic zeolite, a molecular sieve), chemisorbers (e.g., potassium permanganate, calcium carbonate, calcium sulfate, sodium carbonate, sodium hydroxide, calcium hydroxide, powdered metal), ion exchange materials, and catalytic agents (e.g., a catalytic filter). Reactants capable of scavenging gas phase contaminants may also be used with various embodiments of the present invention.

In general, the present invention provides an apparatus comprising an intake vent, followed by a woven pre-filter that serves to remove larger particulate contaminants in the atmosphere, an adsorbent filter and an exhaust vent. The apparatus also includes a device to circulate the air through the aforementioned components. The pre-filter is intended to protect and prolong the life of the physisorbant and/or chemisorbant filter which may be comprised of physisorbers, chemisorbers, ion exchange materials, and catalytic fillers, as well as mixtures of these materials. When the adsorptive capacity of the adsorbent filter has been exhausted, it may be removed from the apparatus, and a new filter cartridge may be inserted in the apparatus.

In one embodiment, the apparatus may be placed in an enclosed space (e.g., a box, a room, a case, etc.) to remove oxidizing agents in the enclosed space and thus retard the spoilage of the foods that are placed in the enclosed space.

In another embodiment, the apparatus may be integrated into food storage apparatuses; for example, refrigerators, freezers, fruit bowls, bread boxes, food transportation storage units, food transportation vehicles and the like.

In another embodiment, the apparatus may also be adapted for use with air circulation systems; for example, air condition systems, heating systems and the like. In such embodiments, the apparatus removes oxidizing agents from a room, a house, an apartment, an office building, a warehouse, an industrial building, a car and the like.

Halides and/or metal halides may be added to the adsorbents. Examples of halides include, but are not limited to, chloride, fluoride, bromide and iodide. Metal halides are compounds between a metal and a halogen. Examples of metal halides include, but are not limited to aluminum chloride, barium chloride, cadmium chloride, cesium chloride, cesium fluoride, cesium iodide, calcium chloride, calcium fluoride, cerium(iii) chloride, chromium(iii) chloride, cobalt(ii) chloride, copper(i) chloride, copper(i) iodide, copper(ii) chloride, gold(iii) chloride, iron(ii) chloride, iron(iii) chloride, lead(ii) chloride, lead(ii) iodide, lithium chloride, magnesium chloride, magnesium fluoride, manganese(ii) chloride, manganese(iv) fluoride, mercury(i) chloride, mercury(ii) chloride, nickel(ii) chloride, plutonium fluoride, potassium chloride, potassium iodide, radium chloride, rhodium(iii) chloride, silver bromide, silver chloride, silver iodide, silver subfluoride, silver(i) fluoride, silver(i) selenide, sodium bromide, sodium chloride, sodium fluoride, sodium iodide, tin(ii) chloride, tin(iv) chloride, titanium tetrachloride, titanium tetraiodide, tungsten hexachloride, tungsten(vi) fluoride, uranium hexafluoride, uranium pentafluoride, uranium tetrafluoride, vanadium tetrachloride, zinc chloride, and zirconium(iv) chloride. Particularly useful metal halides include halides of the following metals: zinc, aluminum, magnesium, calcium and iron.

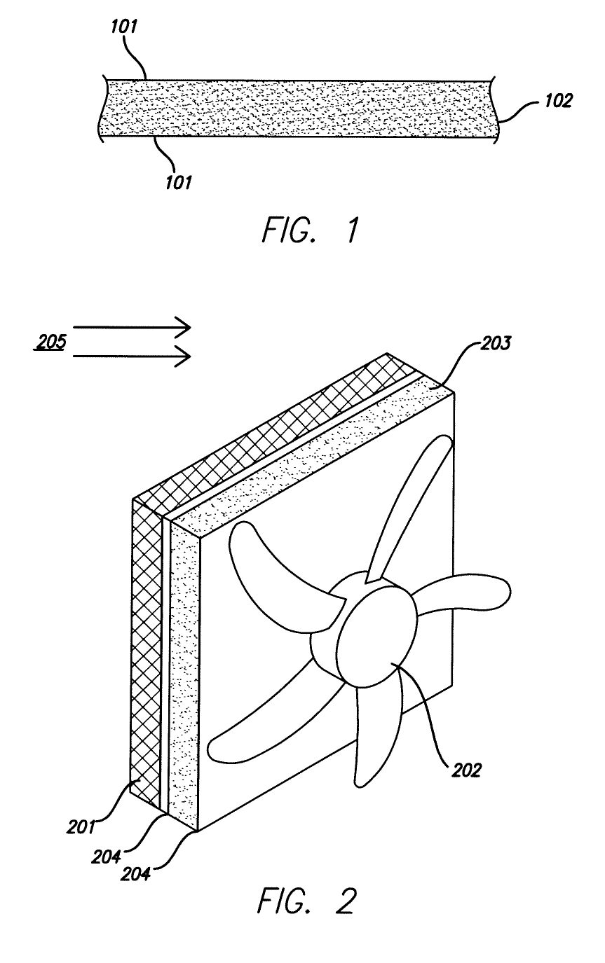

One embodiment of the present invention provides for a filter to remove an oxidizing agent from the air. As shown in FIG. 1, the filter may be made by placing the adsorbent 102 between two or more layers of porous material 101. The porous layer may serve to hold and/or protect the adsorbent. Alternatively, the adsorbent may be adhered to one or more layers of porous material. Halides and/or metal halides may be added to the adsorbents. The filter may be adapted for placement into a cartridge. The filter and/or the cartridge may be disposable. The filter may be adapted for use in conjunction with any food storage apparatuses; for example, refrigerators, freezers, fruit bowls, bread boxes, food transportation storage units, food transportation vehicles and the like. In another embodiment, the filter may be adapted for use with air circulation systems; for example, air condition systems, heating systems and the like. In one embodiment, the filter may be adapted for use on an air vent. In such embodiments, the filter removes oxidizing agents from a room, a house, an apartment, an office building, a warehouse, an industrial building, a car and the like.

The filter may be specifically adapted for use with a refrigerator or freezer. In a particular embodiment, the filter may be adapted for use with the fan mechanism of the refrigerator or freezer. For example, the filter may be placed in a configuration wherein the air that enters into or is circulated in the refrigerator or freezer passes through the filter prior to entering the refrigerator or freezer and thus oxidizing agents are removed by the filter and/or prevented from entering the refrigerator or freezer.

Another embodiment of the present invention provides for an apparatus for retarding the spoilage of food. The apparatus may be used, for example, in enclosures that store food. The apparatus comprises an adsorbent and a device capable of circulating the enclosed air through the adsorbent. The adsorbent may be in the form of an adsorbent filter or an adsorbent filter cartridge as described above. The adsorbent filter or adsorbent filter cartridge may be removable and/or disposable. The apparatus may further comprise an intake vent, a pre-filter and an exhaust vent. The pre-filter is useful for removing particulate contaminants in the surrounding air; for example, dust. The pre-filter may help protect and prolong the functionality of the adsorbent. The device capable of circulating air through the adsorbent may be a fan. The fan may be powered by electricity; for example, via an electric outlet or by battery. Those of skill in the art will recognize many other systems that can provide power to the fan. This invention provides protection against atmospheric oxidizing agents in an enclosed space in which foods are placed. The amount of time that the food would be protected from oxidizing depends on a number of variables, for example, the concentration of oxidizing agents in the environment (e.g., home, refrigerator, freezer, office, restaurant, museum, industrial setting, etc.), relative humidity, and the amount of time during which the enclosing case or space in which the apparatus is placed or used remains open. Additionally, the degree of oxidation would also depend on the constant availability of power to the apparatus; the amount of time during which the food is outside of the enclosed space; and the atmosphere to which the food is exposed.

FIG. 2 depicts a cross sectional view of an apparatus for retarding the spoilage of food. The apparatus comprises a pre-filter 201, a fan 202, and adsorbent 203 between two porous layers 204. The direction of the airflow 205 is first through the pre-filter and then through the adsorbent (contained between porous layers). In embodiments where a pre-filter is used, one of skill in the art will understand that the position of the pre-filter 201, the fan 202 and the adsorbent filter 203 may be placed in any order such that the direction of the airflow is through the pre-filter 201 prior to going through the adsorbent filter 203 as this provides protection to the adsorbent filter 203.

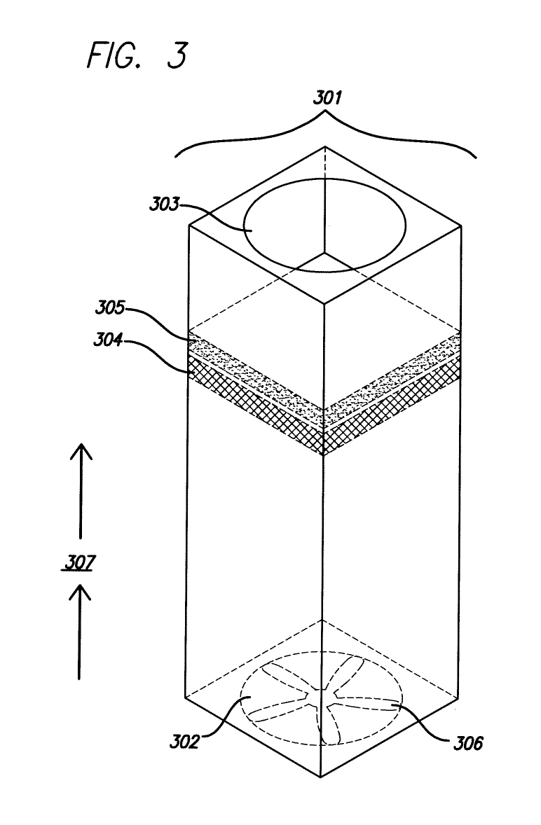

FIG. 3 depicts an apparatus for preventing or reducing the spoilage of food in accordance with another embodiment of the invention. A box 301 comprises an inlet vent 302, an exhaust vent 303, a pre-filter 304, an adsorbent filter 305 and a fan 306. The direction of the airflow 307 is through the inlet vent 302, then through the pre-filter 304, then through the adsorbent filter 305 and out through the exhaust vent 303.

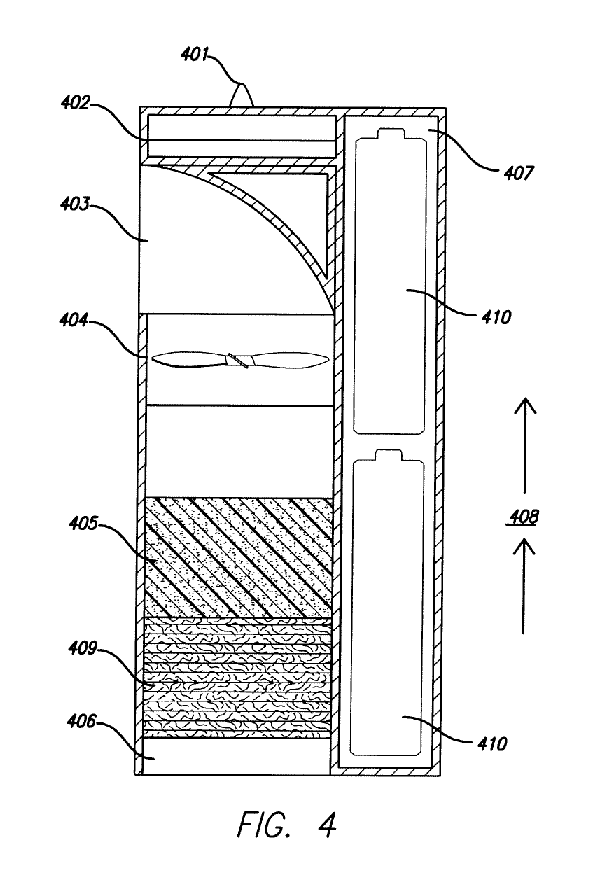

FIG. 4 depicts an apparatus for retarding the spoilage of food in accordance with a particular embodiment of the invention wherein the apparatus may be placed into or adapted for use in a compartment of a refrigerator or freezer such as a drawer. The apparatus may have a light sensor 401 to sense light that is associated with the opening of the refrigerator or freezer. The light sensor is adapted to turn on the apparatus. When the light sensor 401 senses light, the apparatus may be turned on so that new oxidizing agents that enter the drawer may be removed. Alternatively, the light sensor 401 may sense the presence and subsequent absence of light prior to turning on the apparatus. A timing device 402 controls the amount of time that the apparatus operates. The timing device may set a predetermined amount of time for which the apparatus operates in response to the light sensor; for example, the apparatus runs for 10 minutes or any other desirable amount of time after the light sensor senses light. Alternatively, the timer may set a scheduled time wherein the apparatus operates; for example, the apparatus runs for 15 minutes every eight hours, or any other desirable amount of time or time interval. Also included in the apparatus is the air intake vent 406 to allow air to flow into the apparatus, an adsorbent filter 405 to remove the oxidizing agents, a fan 404 to draw the air into and out of the apparatus, and an air exhaust vent 403 to allow the air to flow out of the apparatus. The apparatus may also have a pre-filter 409 to remove particulate contaminants and a battery compartment 407 with batteries 410 to power the apparatus. Alternatively, the apparatus may be adapted to obtain electricity from an external power source. The direction of air flow 408 is also depicted in FIG. 4.

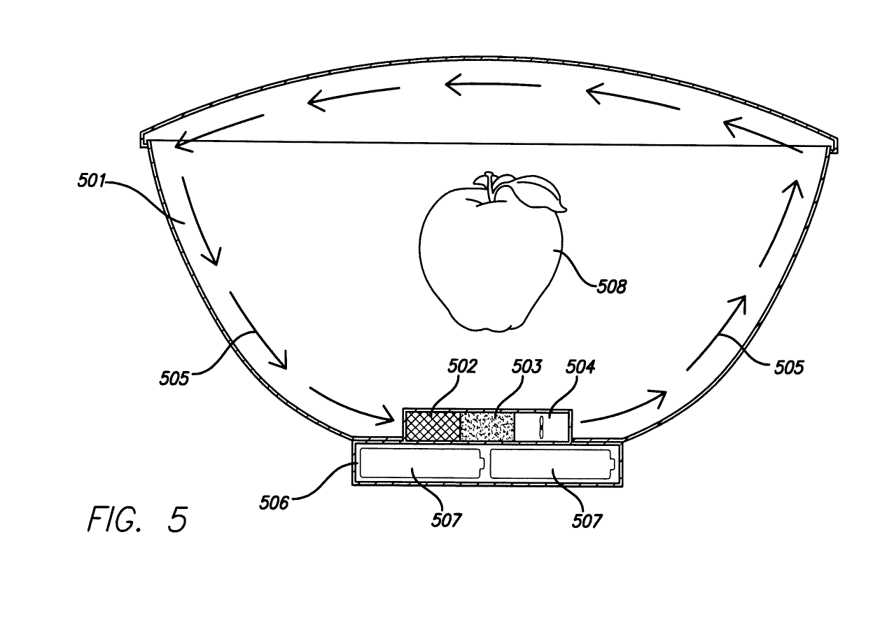

FIG. 5 depicts an enclosed bowl for preventing or reducing the spoilage of food, particularly fruit and vegetables, in accordance with another embodiment of the invention. Integrated into the bowl 501 is an adsorbent filter 503, a fan 504 to circulate the air through the adsorbent filter and a battery compartment 506 with batteries 507 at the base of the bowl. Fruit 508 may be placed in the bowl, although the fruit 508 itself is not a component of the apparatus. Alternatively, the electricity to power the apparatus may be from an external source. An air intake vent, to allow air to flow through the apparatus, a pre-filter 502 to remove particulate contaminants, and an air exhaust vent to allow air to flow out of the apparatus may also be integrated into the bowl 501. The air flow 505 is also depicted in FIG. 5.

While the description above refers to particular embodiments of the present invention, it should be readily apparent to people of ordinary skill in the art that a number of modifications may be made without departing from the spirit thereof. The accompanying claims are intended to cover such modifications as would fall within the true spirit and scope of the invention. The presently disclosed embodiments are, therefore, to be considered in all respects as illustrative and not restrictive, the scope of the invention being indicated by the appended claims rather than the foregoing description. All changes that come within the meaning of and range of equivalency of the claims are intended to be embraced therein.

What is claimed is:

1. An apparatus for preventing or reducing the oxidation of food, comprising:
an adsorbent; and
a device to circulate air through said adsorbent to remove an agent that causes or contributes to the oxidation of food.

2. The apparatus of claim 1, further comprising a first porous layer,
wherein said adsorbent is adhered to or non-adheredly placed next to said first porous layer, whereby an adsorbent filter is created.

3. The apparatus of claim 2, further comprising a second porous layer,
wherein said adsorbent is configured between said first porous layer and said second porous layer.

4. The apparatus of claim 1, further comprising:
an intake vent to allow air to flow into said apparatus;
a pre-filter to remove a particulate contaminant prior to allowing the air to flow through said adsorbent; and
an exhaust vent to allow air to flow out of said apparatus.

5. The apparatus of claim 1, further comprising a removable filter cartridge that encases said adsorbent.

6. The apparatus of claim 1, wherein said adsorbent is selected from the group consisting of a physisorber, a chemisorber, an ion exchange material, a catalytic agent and combinations thereof.

7. The apparatus of claim 6, wherein said physisorber is selected from the group consisting of activated carbon, activated alumina, silica, silica gel, natural zeolite, synthetic zeolite, a molecular sieve and combinations thereof, and said chemisorber is selected from the group consisting of potassium permanganate, calcium carbonate, calcium sulfate, sodium carbonate, sodium hydroxide, calcium hydroxide, powdered metal, a reactant capable of scavenging gas phase contaminants and combinations thereof.

8. The apparatus of claim 2, wherein said adsorbent filter further comprises a halide or a metal halide.

9. The apparatus of claim 8, wherein the metal of said metal halide is selected from the group consisting of zinc, aluminum, magnesium, calcium, iron and combinations thereof.

10. The apparatus of claim 1, further comprising a timing device to control an amount of time that the apparatus operates.

11. The apparatus of claim 1, further comprising a light sensor adapted to turn on the apparatus.

12. The apparatus of claim 1, wherein the apparatus is adapted for use in a food storage unit selected from the group consisting of a refrigerator, a freezer, a fruit bowl, a bread box and combinations thereof.

13. The apparatus of claim 1, wherein the apparatus is adapted for use in an air circulation system.

14. A filter adapted for preventing or reducing the oxidation of food, comprising:
an adsorbent to remove an oxidizing agent; and
a porous layer to hold and/or protect said adsorbent,
wherein said adsorbent is selected from the group consisting of activated carbon, activated alumina, silica, silica gel, natural zeolite, synthetic zeolite, a molecular sieve, potassium permanganate, calcium carbonate, calcium sulfate, sodium carbonate, sodium hydroxide, calcium hydroxide, powdered metal, a reactant capable of scavenging gas phase contaminants, an ion exchange material, a catalytic agent and combinations thereof.

15. The filter of claim 14, further comprising a halide or a metal halide added to said adsorbent.

16. The filter of claim 15, wherein the metal of said metal halide is selected from the group consisting of zinc, aluminum, magnesium, calcium, iron and combinations thereof.

17. The filter of claim 14, wherein said filter is adapted for use in a food storage unit selected from the group consisting of a refrigerator, a freezer, a fruit bowl, a bread box and combinations thereof.

18. The filter of claim 14, wherein said filter is adapted for use in an air circulation system.

19. A method for inhibiting or reducing the oxidation of food, comprising:
providing an apparatus comprising:
an adsorbent; and
a device to circulate air through said adsorbent to remove an agent that causes or contributes to the oxidation of the food; and
circulating the air through said apparatus to prevent or reduce the oxidation of the food.

20. The method of claim 19, wherein said apparatus further comprises a first porous layer,
wherein said adsorbent is adhered to or non-adheredly placed next to said first porous layer, whereby an adsorbent filter is created.

21. The method of claim 20, wherein said apparatus further comprises a second porous layer,
wherein said adsorbent is configured between said first porous layer and said second porous layer.

22. The method of claim 19, wherein said apparatus further comprises:
an intake vent to allow air to flow into said apparatus;
a pre-filter to remove a particulate contaminant prior to allowing the air to flow through said adsorbent; and
an exhaust vent to allow air to flow out of said apparatus.

23. The method of claim 19, wherein said adsorbent is selected from the group consisting of a physisorber, a chemisorber, an ion exchange material, a catalytic agent and combinations thereof.

24. The method of claim 23, wherein said physisorber is selected from the group consisting of activated carbon, activated alumina, silica, silica gel, natural zeolite, synthetic zeolite, a molecular sieve and combinations thereof, and said chemisorber is selected from the group consisting of potassium permanganate, calcium carbonate, calcium sulfate, sodium carbonate, sodium hydroxide, calcium hydroxide, powdered metal, a reactant capable of scavenging gas phase contaminants and combinations thereof.

25. The method of claim 20, wherein said adsorbent filter further comprises a halide or a metal halide.

26. The method of claim 25, wherein the metal of said metal halide is selected from the group consisting of zinc, aluminum, magnesium, calcium, iron and combinations thereof.

27. An apparatus to slow down the spoilage of food, comprising:
a container to store the food;
an adsorbent filter to remove an oxidizing agent;
a fan to circulate the air through said adsorbent filter; and
a base adapted to provide electricity to said apparatus.
